(19) United States
(12) Patent Application Publication
(10) Pub. No.: US 2017/0277993 A1
(43) Pub. Date: Sep. 28, 2017

(54) VIRTUAL ASSISTANT ESCALATION

(71) Applicant: Next IT Corporation, Spokane Valley, WA (US)

(72) Inventors: Ian Beaver, Spokane Valley, WA (US); Fred A. Brown, Colbert, WA (US); Cynthia Freeman, Albuquerque, NM (US)

(21) Appl. No.: 15/465,412

(22) Filed: Mar. 21, 2017

Related U.S. Application Data
(60) Provisional application No. 62/311,833, filed on Mar. 22, 2016.

(51) Int. Cl. G06N 3/00; G06N 99/00

(52) U.S. Cl. CPC G06N 3/006; G06N 99/005

(57) ABSTRACT

Techniques and architectures for analyzing conversations between users and virtual assistants to identify instances where the virtual assistants have not satisfied user requests are described. The techniques and architectures may use such analysis to tag conversations regarding unsatisfied user requests, provide information to users regarding conversations with unsatisfied user requests, learn conversation or contextual data for unsatisfied user requests, and/or perform a variety to other processes to improve the virtual assistants.

### RELATED APPLICATIONS

This application claims the benefit of U.S. Provisional Application No. 62/311,833, filed Mar. 22, 2016, the entire contents of which are incorporated herein by reference. This application is also related to U.S. patent application Ser. No. 14/467,221, filed Aug. 25, 2014, which is incorporated herein by reference.

### BACKGROUND

A growing number of people are using smart devices, such as smart phones, tablet computers, laptop computers, and so on, to perform a variety of functionality. In many instances, the users interact with their devices through a virtual assistant. The virtual assistant may communicate with a user to perform a desired service or task, such as searching for content, checking-in to a flight, setting a calendar appointment, and so on. In some instances, a conversation with a virtual assistant is escalated to a human representative so that the human representative can provide a response to the user. As more users interact with smart devices through virtual assistants, there is an increasing need to enhance the user's experience with virtual assistants.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture in which techniques described herein may be implemented.

FIG. 2 illustrates an example process for learning data associated with a failure of a virtual assistant.

FIG. 3 illustrates an example process for learning data associated with an escalation to a human representative and escalating a conversation based on such learning.

FIGS. 4A-4B illustrate an example process to filter conversations and/or turns.

FIG. 5 illustrates details of an example virtual assistant service.

FIG. 6 illustrates details of an example smart device.

### DETAILED DESCRIPTION

This disclosure describes, in part, techniques and architectures for analyzing conversations between users and virtual assistants to identify instances where the virtual assistants have not satisfied user requests. The techniques and architectures may use such analysis to tag conversations regarding unsatisfied user requests, provide information to users regarding conversations with unsatisfied user requests, learn conversation or contextual data for unsatisfied user requests, and/or perform a variety to other processes to improve the virtual assistants.

To illustrate, the techniques and architectures may analyze a conversation to identify a failure in the conversation that is attributable to a virtual assistant. This may include determining that an escalation (or particular type of escalation) to a human representative occurred to resolve an issue for a user, determining that the virtual assistant was unable to provide a response or perform a task that satisfied a user request, determining that a sentiment of the user changed during the conversation (e.g., the user was upset at a response), and so on.

In some instances, the techniques and architectures may flag conversations (or portions of conversations) based on such determinations and provide those flagged conversations to users to review. The users may determine why the virtual assistant failed in the conversation and update the virtual assistant (including an underlying NLP system) so that the failure does not occur again. By flagging failures of virtual assistants (or particular types of failures that are attributable to performance of the virtual assistants) (where the failures include performance of the underlying NLP system in determining its understanding, generating a response, etc.), the techniques and architectures may avoid the user having to review thousands of failures that are not attributable to the performance of the virtual assistants. For example, the techniques and architectures may avoid a user from having to review all escalations, and allow the user to review a select few of escalations that are due to a failure of the virtual assistant (e.g., which may be less than 10, 20, or 30% of all types of escalations, in some cases).

Further, in some instances the techniques and architectures may learn that contextual data and/or conversation data is associated with a failure of a virtual assistant. When such contextual data and/or conversation data is identified in a later conversation, an action may be performed by the virtual assistant to preemptively address a potential issue. For example, the virtual assistant may transfer a user to a human representative when it detects contextual data that is associated with a previous escalation to a human representative. Conversation data may include a variety of information associated with processing conversation input/output, such as data determined through Natural Language Processing (NLP), response formulation, and so on. Meanwhile, contextual data may include a variety of information that is generally external to processing conversation input/output, such as a user location, pervious conversations, buying preferences, a status, a time, a date, sensor readings, user sentiment, user profile information, etc.

This brief introduction is provided for the reader's convenience and is not intended to limit the scope of the claims, nor the proceeding sections. Furthermore, the techniques described in detail herein may be implemented in a number of ways and in a number of contexts. Some example implementations and contexts are provided with reference to the following figures, as described below in more detail. It is to be appreciated, however, that the following implementations and contexts are but some of many.

### Example Architecture

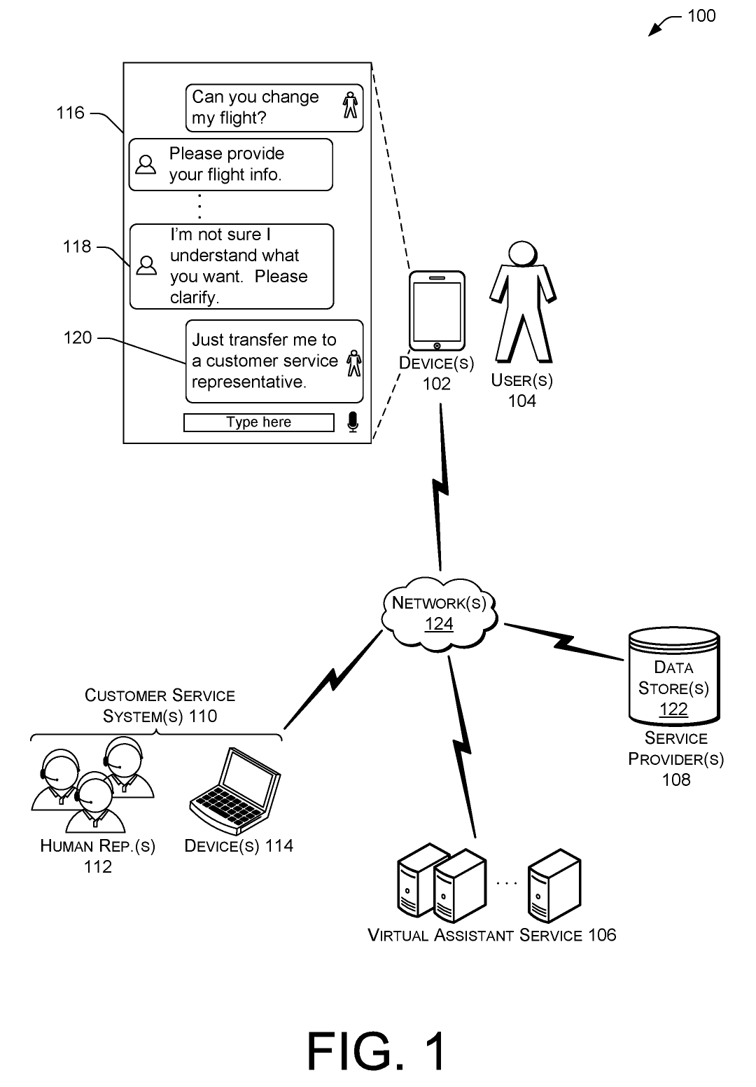

FIG. 1 illustrates an example architecture 100 in which techniques described herein may be implemented. The architecture 100 includes one or more smart devices 102 (hereinafter “the smart device 102”) to present a virtual assistant to one or more end-users 104 (hereinafter “the user 104”) to perform tasks for the user 104. The virtual assistant may be implemented in cooperation with a virtual assistant service 106 that generally manages functionality of the virtual assistant. As the virtual assistant performs tasks, the virtual assistant may communicate with one or more services providers 108 (hereinafter “the service provider 108”). The architecture 100 also includes one or more customer service systems 110 (hereinafter “the customer service system 110”) to communicate with the user 104 in some instances. For example, if a particular situation is detected during a conversation between the virtual assistant and the user, such as the user 104 requesting a human representative, the virtual assistant not being able to satisfy a request, etc., the virtual assistant may transfer the conversation to the customer service system 110 to handle the conversation (e.g., respond to the user, perform a task for the user, etc.). The customer service system 110 may include one or more human representatives 112 (hereinafter “the human representative 112”) and one or more computing devices 114 (hereinafter “the computing device 114”) that are employed by the human representative 112. In some instances, the customer service system 110 is implemented as a call center where communications are facilitated by telephone, email, messaging (e.g., online chat (instant messaging), text message, etc.), video conferences, audio conferences, and so on. In other instances, the customer service system 110 may be implemented in other manners, such as an individual of a company that is designated to handle issues for the company, a crowd-sourced manner where individuals located at various locations are designated as customer service representatives, and so on.

The smart device 102 (and/or the computing device 114) may comprise any type of computing device that is configured to perform an operation. For example, the smart device 102 (and/or the computing device 114) may be implemented as a laptop computer, a desktop computer, a server, a smart phone, an electronic reader device, a mobile handset, a personal digital assistant (PDA), a portable navigation device, a portable gaming device, a tablet computer, a wearable computer (e.g., a watch, a pair of glass with computing capabilities, etc.), a portable media player, a television, a set-top box, a computer system in a car, an appliance, a camera, a robot, a hologram system, a security system, a home-based computer system (e.g., intercom system, home media system, etc.), a telephone, a projector, an automated teller machine (ATM), and so on.

In the example of FIG. 1, the smart device 102 outputs the virtual assistant to the user 104 via a conversation user interface 116. Although in other instances, the virtual assistant may be output in other manners, such as audibly, etc. The virtual assistant may interact with the user 104 in a conversational manner to perform tasks. For example, in response to a query from the user 104 to “find the nearest restaurant,” the virtual assistant may provide information through the conversation user interface 116 that identifies the nearest restaurant. As such, in many instances, the user 104 and/or the virtual assistant may communicate in a natural language format. The virtual assistant may be configured for multi-modal input/output (e.g., receive and/or respond in audio or speech, text, touch, gesture, etc.), multi-language communication (e.g., receive and/or respond according to any type of human language), multi-channel communication (e.g., carry out conversations through a variety of computing devices, such as continuing a conversation as a user transitions from using one computing device to another), and/or other types of input/output or communication.

In some implementations, a virtual assistant may comprise an intelligent personal assistant. A virtual assistant may generally perform tasks for users and act as an interface to information of the service provider 108, information associated with the smart device 102, information of the virtual assistant service 106, or any other type of information. For example, in response to input from the user 104, the virtual assistant may access content items stored by the service provider 108 and provide a content item to the user 104.

Further, in some implementations a virtual assistant may embody a human-like persona and/or artificial intelligence (AI). For example, a virtual assistant may be represented by an image or avatar that is displayed on the smart device 102. An avatar may comprise an animated character that may take on any number of shapes and appearances, and/or resemble a human talking to a user. In some instances, the avatar may be arranged as a representative of the service provider 108 or the virtual assistant service 106, while in other instances the avatar may be a dedicated personal assistant to a user.

In some instances, the conversation user interface 116 is a dedicated interface for the smart device 102 (e.g., built into an operating system of the smart device 102, a mobile application for a mobile device, etc.). In other instances, the conversation user interface 116 is associated with the service provider 108 and/or the virtual assistant service 106. To illustrate, the conversation user interface 116 may be displayed through an online site of a service provider when the user navigates to the online site. Here, the conversation user interface 116 may include a virtual assistant that embodies characteristics of the service provider, such as a flight attendant for an online airline site. Although many examples are described herein in the context of visually displayed user interfaces, these techniques may be implemented with audible user interfaces (e.g., presented through a speaker of a smart device) or other types of interfaces.

In the example of FIG. 1, the conversation user interface 116 illustrates a conversation that is escalated to the human representative 112 of the customer service system 110. In particular, after some back-and-forth between the user 104 and the virtual assistant, the virtual assistant states, at 118, that it is unable to understand the user 104 and requests clarifying information (“I'm not sure I understand what you want. Please clarify.”). In response, and out of frustration with the virtual assistant, the user 104 asks, at 120, to be transferred to a customer service representative (“Just transfer me to a customer service representative.”). As such, the user 104 is transferred to the customer service system 110 to communicate with the human representative 112 via telephone, email, messaging (e.g., online chat (instant messaging), text message, etc.), video conferencing, audio conferencing, and so on. The human representative 112 may respond to the user 104 and/or perform a task for the user 104.

Although not illustrated in FIG. 1, in some instances the human representative 112 may communicate with the user 104 without the user 104 knowing that the human representative 112 is involved. For example, the human representative 112 may provide responses to the user 104 via the conversation user interface 116, and conversation items in the conversation user interface 116 (e.g., the item at 118) may appear as if they are originating from the virtual assistant. This may allow the human representative 112 to be seamlessly involved in the conversation as the virtual assistant.

In many instances, a virtual assistant may be implemented, at least in part, in cooperation with the virtual assistant service 106. The virtual assistant service 106 may provide one or more services to implement a virtual assistant. In general, the virtual assistant service 106 may operate as a “back-end” resource to the smart device 102 or other devices. Although the virtual assistant is discussed in the context of being implemented at least in part by the virtual assistant service 106, in some instances the virtual assistant may be implemented entirely by a client device, such as the smart device 102.

The virtual assistant service 106 may include one or more computing devices. The one or more computing devices may be implemented as one or more desktop computers, laptop computers, servers, and so on. The one or more computing devices may be configured in a cluster, data center, cloud computing environment, or a combination thereof. In one example, the virtual assistant service 106 provides cloud computing resources, including computational resources, storage resources, networking resources, and the like, that operate remotely to the smart device 102 or other devices.

In some instances, the virtual assistant service 108 may communicate with the service provider 108 to access data and/or utilize services in order to implement the virtual assistant. The service provider 108 may include one or more data stores 118 for storing content items, such as web pages, documents, media (e.g., music, video, etc.), advertisements, etc. For example, the one or more data stores 122 may include a mobile web data store, a smart web data store, an information and content data store, a content management service (CMS) data store, and so on. A mobile web data store may store content items that are designed to be viewed on a mobile device, such as a mobile telephone, tablet device, etc. Meanwhile, a web data store includes content items that are generally designed to be viewed on a device that includes a relatively large display, such as a desktop computer. An information and content data store may include content items associated with an application, content items from a data base, and so on. A CMS data store may include content items providing information about a user, such as a user preference, user profile information, information identifying offers that are configured for a user based on profile and purchase preferences, etc. As such, the service provider 108 may include content items from any type of source.

Although the one or more data stores 122 are illustrated as being included in the service provider 108, the one or more data stores 122 may alternatively, or additionally, be included in the virtual assistant service 106, the smart device 102, and/or the computing device 114. Further, although the service provider 108 is illustrated as a collection of the one or more data stores 122, the service provider 108 may be associated with one or more computing devices, such as one or more servers, desktop computers, laptop computers, or any other type of device configured to process data. In some instances, the one or more computing devices may be configured in a cluster, data center, cloud computing environment, or a combination thereof.

The architecture 100 may also include one or more networks 124 to enable the smart device 102, the virtual assistant service 106, the customer service system 110 (including the computing device 114), and/or the service provider 108 to communicate with each other. The one or more networks 124 may include any one or combination of multiple different types of networks, such as cellular networks, wireless networks, Local Area Networks (LANs), Wide Area Networks (WANs), the Internet, and so on.

Although the virtual assistant service 106 is illustrated in FIG. 1 as a single service, in some instances the virtual assistant service 106 may be divided or otherwise separated (e.g., by location, computing hardware/resources, and so on) into several services to implement the various aspects of the techniques discussed herein. For example, a first service may be implemented to learn contextual/conversation data, a second service may be implemented to carry out virtual assistant conversations, a third service may be implemented to facilitate conversations with human representatives, and so on.

### Example Processes

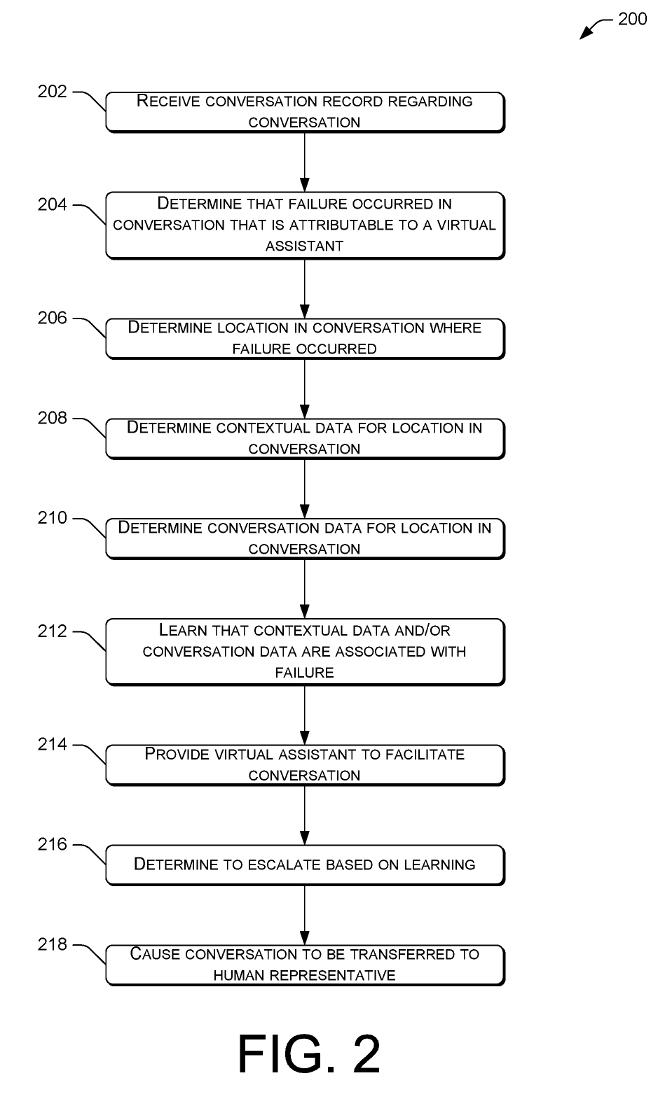

FIGS. 2-4 illustrate example processes 200, 300, and 400 for employing the techniques described herein. For ease of illustration the processes 200, 300, and 400 are described as being performed in the architecture 100 of FIG. 1. For example, one or more of the individual operations of the processes 200, 300, and 400 may be performed by the smart device 102, the virtual assistant service 106, and/or the computing device 114. However, the processes 200, 300, and 400 may be performed in other architectures. Moreover, the architecture 100 may be used to perform other processes.

The processes 200, 300, and 400 (as well as each process described herein) are illustrated as a logical flow graph, each operation of which represents a sequence of operations that can be implemented in hardware, software, or a combination thereof. In the context of software, the operations represent computer-readable instructions stored on one or more computer-readable storage media that, when executed by one or more processors, perform the recited operations. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process. Further, any number of the described operations may be omitted.

FIG. 2 illustrates the example process 200 for learning data associated with a failure of a virtual assistant.

At 202, the virtual assistant service 106 may receive a conversation record regarding a conversation between a virtual assistant and a user. The conversation record may be stored at the virtual assistant service 106, the smart device 102, or elsewhere. As such, the conversation record may be received from a data store of the virtual assistant service 106, the smart device 102, or another source.

The conversation record may generally include a record of input from a user, output from a virtual assistant, and/or input/output from a human representative. The conversation record may include a series of dialogue turns (often referred to as “turns”). Each dialogue turn may correspond to an utterance of one of the participants in the conversation, which may or may not be represented with a visual representation in a conversation user interface (e.g., a speech bubble). In some instances, the conversation record is formatted with tags or other markers that indicate transitions between the participants in the conversation, while in other instances processing is performed by the virtual assistant service 106 to tag or mark the conversation record. In some instances, the conversation record includes dialogue turns from a human representative, such as the human representative 112 of the customer service system 110. As such, the conversation record may indicate that a human representative was involved in the conversation (e.g., that the conversation was escalated to a human representative).

At 204, the virtual assistant service 106 may determine that a failure occurred in the conversation that is attributable to a virtual assistant. For instance, the virtual assistant service 106 may determine that the virtual assistant attempted to satisfy a user request but failed to do so.

As one example of operation 204, the virtual assistant service 106 may determine that a virtual assistant was unable to provide a response or perform a task that satisfied user input in a conversation. To illustrate, the user may request “please upgrade my seat to first class.” If the virtual assistant service 106 asks a series of questions to upgrade the user's seat, and is ultimately unable to perform such task, the user may later repeat the same request “please upgrade my seat to first class.” In this illustration, the virtual assistant service 106 may determine that the virtual assistant was unable to provide a response or perform a task that satisfied the user request, since the user repeated the same question over a particular number of dialogue turns.

As another example of operation 204, the virtual assistant service 106 may determine that an escalation to a human representative occurred in a conversation. In some instances, operation 204 may include determining that at least one dialogue turn in the conversation corresponds to a human representative. In other instances, operation 204 may include determining that the conversation was sent to a human representative. Here, the human representative may or may not have responded (e.g., the conversation may have merely been transferred, a task performed, and then ended).

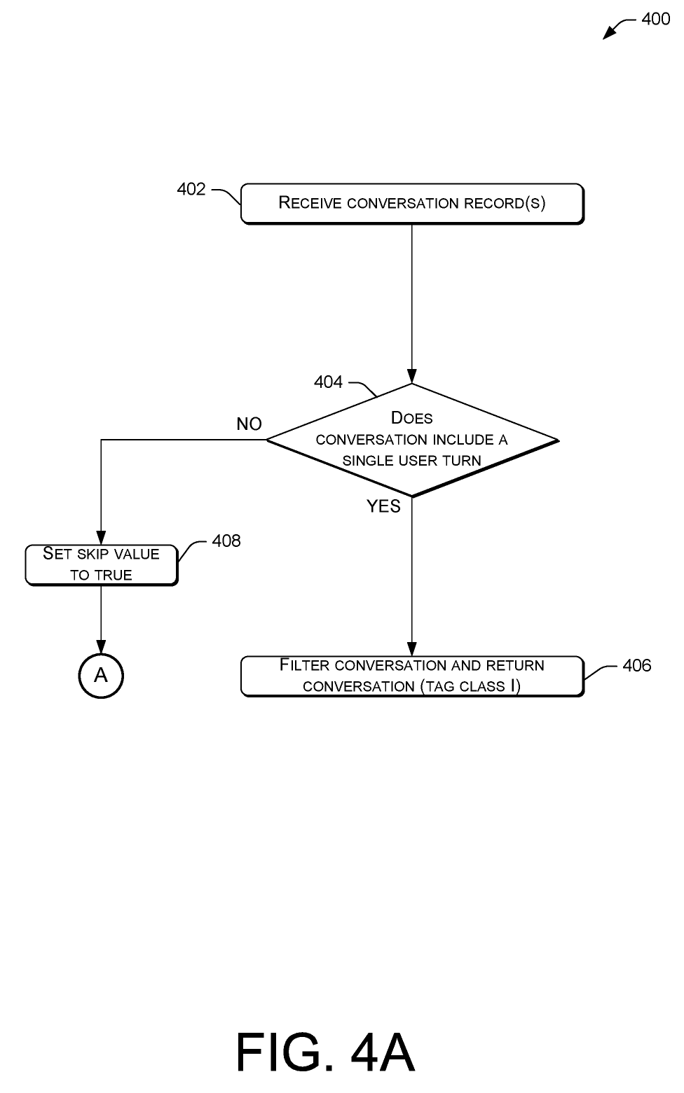

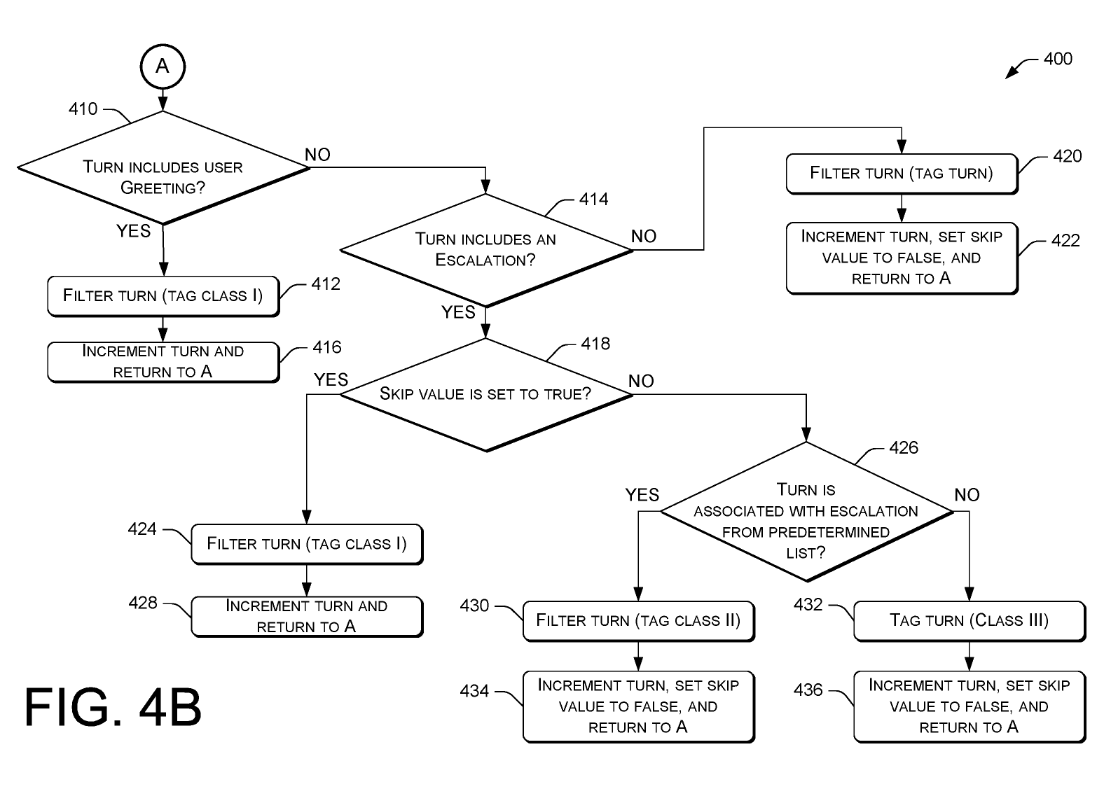

In some instances where an escalation is identified, the virtual assistant service 106 may determine that a failure is attributable to a virtual assistant when the escalation is a particular type of escalation. Such escalation (or failure) is sometimes referred to as a “class III” escalation (or failure). To identify such failure, the virtual assistant service 106 may perform a filtering process, which may include one or more of the operations described in reference to FIGS. 4A and 4B. The filtering process may determine that the conversation does not include a single user turn. A conversation with a single user input may comprise a conversation that includes zero or more turns from a virtual assistant, but only a single turn from the user. In many cases, a conversation that is escalated after a single user turn may indicate the user requested to communicate with a human representative right away and did not provide the virtual assistant with an opportunity to assist the user. Such escalation is not considered a failure of the virtual assistant.

Further, the filtering process may determine that a conversation includes at least one user turn that is (i) not related to an escalation and (ii) not related to a user greeting. In many cases, a conversation that is escalated directly after a user greeting may indicate that the user greeted the virtual assistant and then requested a transfer to a human representative (e.g., user: “I am doing well today”; virtual assistant: “glad to hear it”; user: “please transfer me to a customer service representative”). Such escalation is not considered a failure of the virtual assistant.

Moreover, the filtering process may determine that an escalation is not included in a list of predetermined escalations. The list of predetermined escalations may include escalations that the virtual assistant is required to perform, such as those specified by regulations or laws (e.g., human representatives are required when receiving personal identifying information, such as a social security number), business practices, answering legal or medical questions, or otherwise pre-configured in the virtual assistant. In many cases, a conversation that is escalated based on a configuration to do so, it not a failure of the virtual assistant.

Based on one or more of the determinations mentioned above, the filtering process may determine that a failure is attributable to the virtual assistant. That is, the filtering process may determine that the virtual assistant attempted to perform a task or provide a response for a user, but failed to do so, and thus, the conversation was transferred to a human representative to handle.

As another example of operation 204, the virtual assistant service 106 may determine that a sentiment of a user changed from a first state to a second state during a conversation. For example, the virtual assistant service 106 may determine that a sentiment of a user changed from happy or content to sad or angry in response to a virtual assistant providing a particular response or performing a particular task for the user. Such change in sentiment may indicate that the user was not satisfied with the virtual assistant's performance. To determine a sentiment of a user, the virtual assistant service 106 may determine that a user used terms that are associated with a particular sentiment, determine that a concept of a conversation was identified that is associated with a particular sentiment, determine that a facial expression was expressed by a user that is associated with a particular sentiment (e.g., analyze images of a user's face taken by a camera), determine that the user's device was moved in a manner that is associated with a particular sentiment (e.g., data from an accelerometer, magnetometer, or other sensor indicates that the user shook a phone to indicate that he was angry), determine that the user's blood pressure or heart rate changed up or down by a particular amount, and so on.

At 206, the virtual assistant service 106 may determine a location in a conversation where a failure occurred. For example, the virtual assistant service 106 may determine a time in the conversation when an escalation occurred (e.g., time stamp, time relative to conversation, time of day, etc.), a turn(s) in the conversation where an escalation occurred (e.g., right after user turn number twelve), and so on.

At 208, the virtual assistant service 106 may determine contextual data for a location in a conversation where a failure occurred. For example, the virtual assistant service 106 may identify contextual data that corresponds to a time of escalation to a human representative. The contextual data may have been generated or collected at a specific time when the escalation occurred or within a window of time that includes the specific time of the escalation. Example contextual data may include a geographic location of the user when the failure occurred, a sentiment of the user when the failure occurred, a sensor reading from the smart device for when the failure occurred (e.g., an accelerometer/magnetometer reading, temperature reading, blood pressure reading, heart rate reader, etc.), a calendar event during a period of time that includes the failure, weather conditions when the failure, a time of day when the failure occurred, an input mode used by the user when the failure occurred, user profile information for the user, background noise that occurred in the conversation when the failure occurred, and so on.

At 210, the virtual assistant service 106 may determine conversation data for a location in a conversation where a failure occurred. For example, the virtual assistant service 106 may identify conversation data that corresponds to a time of an escalation to a human representative. The conversation data may have been produced or determined for user input or virtual assistant output at a specific time when the escalation occurred or within a window of time that includes the specific time of the escalation. Example conversation data may include user input at an escalation (e.g., user input right before an escalation (within a particular number of user turns of the escalation)), a response of the virtual assistant at the escalation (e.g., a response right before an escalation (within a particular number of virtual assistant turns of the escalation)), a goal that is determined for responding to the user input at the escalation, a task that was performed by the virtual assistant at the escalation (e.g., a task performed right before an escalation), Natural Language Processing (NLP) output from processing the user input at the escalation (e.g., any data that is determined by a NLP system), a duration of time in the first conversation up to the escalation (e.g., an escalation occurred 2 minutes into the conversation), a number of turns in the first conversation up to the escalation (e.g., an escalation occurred 3 user turns into the conversation), a length of the user input or virtual assistant output at the escalation (e.g., a number of characters or terms used by the user or virtual assistant right before an escalation), and so on.

At 212, the virtual assistant service 106 may learn that contextual data and/or conversation data are associated with a failure of the virtual assistant. Operation 212 may include storing data that correlates the contextual data and/or the conversation data to a failure of the virtual assistant. As one example, upon identifying that conversations of a user are frequently escalated to a human representative (e.g., more than a predetermined number of times) when the user is at the airport, has a particular heart rate (e.g., a relatively high heart rate), and the concept of flight security is discussed with the virtual assistant, the virtual assistant service 106 may store a correlation between such contextual/conversation data and escalation. As another example, upon identifying that a user frequently expresses an angry sentiment when the concept of basketball scores are discussed and when the virtual assistant provides a particular response (e.g., user: “what was the score of the basketball game”; virtual assistant: “here's some results I found on the web”), the virtual assistant service 106 may store a correlation between such contextual/conversation data and an angry sentiment (and/or a failure of the virtual assistant).

Additionally, or alternatively, operation 212 may include formulating conditions (or setting triggering parameters and/or values of the triggering parameters) for the virtual assistant based on the correlations. In returning to the first example above, the virtual assistant service 106 may specify conditions to automatically trigger an escalation when the user is at the airport, has a relatively high heart rate, and discusses the concept of flight security. In returning to the second example mentioned above, the virtual assistant service 106 may specify conditions to automatically trigger performance of an action different than searching the web (e.g., open a mobile app directed to sports) when the concept of basketball scores is discussed.

In some instances, the virtual assistant service 106 may collect conversation records over time and learn correlations between contextual/conversation data and failures of virtual assistants. The conversation records may be for the same user, different users, the same virtual assistant, different virtual assistants, the same industries, different industries, and so on. To illustrate, the virtual assistant service 106 may learn that escalations frequently occur (e.g., more than a predetermined number) in conversations with users that are associated with a particular user profile (e.g., users over a particular age) and when the concept of administering medication is discussed.

At 214, the virtual assistant service 106 may provide a virtual assistant via a smart device to facilitate a conversation. The virtual assistant may be configured according to the learning at operation 212 (e.g., configured to perform a particular action, such as escalating a conversation when one or more conditions are satisfied). In one example, the virtual assistant service 106 may cause a virtual assistant to be output on the smart device 102 by sending an instruction or data to the smart device 102 instructing the smart device 102 to output the virtual assistant through a local client application. In another example, the virtual assistant service 106 may output a virtual assistant through a web page. In yet other examples, a virtual assistant may be provided in other manners.

At 216, the virtual assistant service 106 may determine to escalate based on the learning at 212. For example, the virtual assistant service 106 may monitor conversation data and/or contextual data during a conversation to detect that one or more conditions associated with an escalation are satisfied. In returning to the example above where an airport, a relatively high heart rate, and discussing the concept of flight security are specified as conditions, the virtual assistant service 106 may determine to escalate a conversation when the user is at an airport, has a relatively high heart rate, and discussed the concept of flight security.

At 218, the virtual assistant service 106 may cause the conversation to be transferred to a human representative. Operation 218 may occur in response to the determination at 216. Operation 218 may include enabling a human representative to initiate a conversation with the user (e.g., putting the human representative in contact with the user). In some instances, the human representative may review the conversation that has occurred up to the point of escalation. In other instances, such information may not be provided.

In some implementations, the human representative may converse with the user as if the human representative were the virtual assistant (e.g., without the user knowing that the conversation has been transferred to a human representative). This may be facilitated by maintaining a same conversation user interface with the user (e.g., with dialogue representations from the human representative being presented as originating from the virtual assistant).

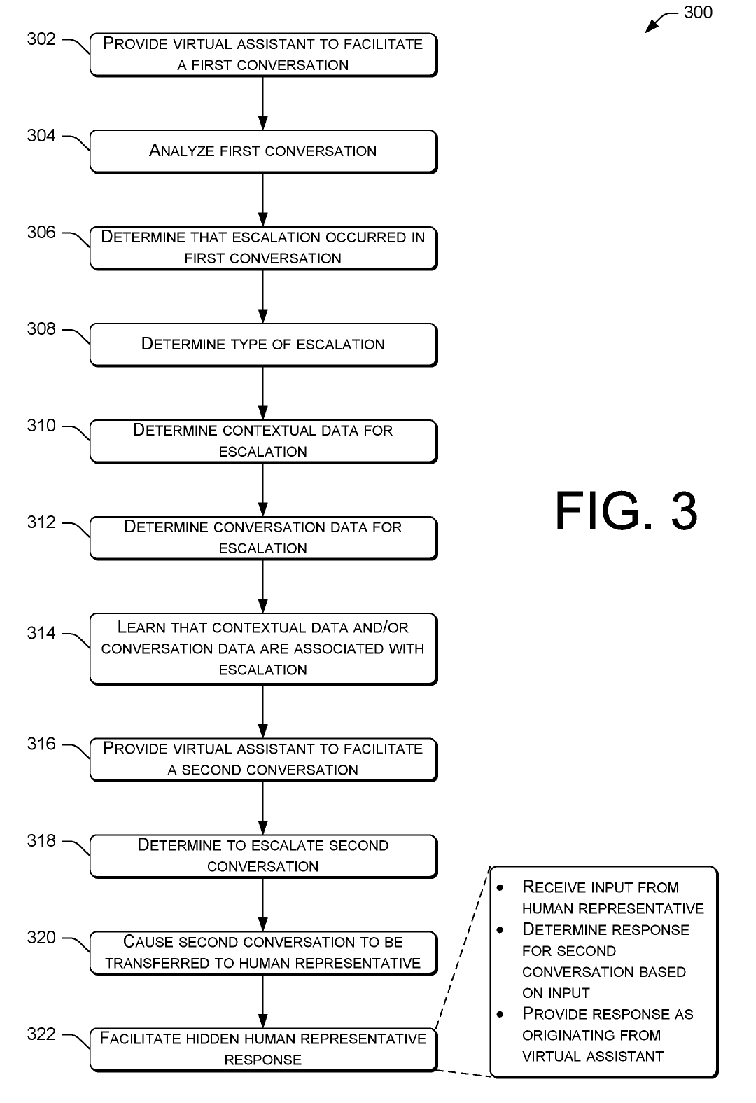

FIG. 3 illustrates the example process 300 for learning data associated with an escalation to a human representative and escalating a conversation based on such learning.

At 302, the virtual assistant service 106 may provide a virtual assistant to facilitate a first conversation between a virtual assistant and a user. In one example, the virtual assistant service 106 may cause a virtual assistant to be output on the smart device 102 by sending an instruction or data to the smart device 102 instructing the smart device 102 to output the virtual assistant through a local client application. In another example, the virtual assistant service 106 may output a virtual assistant through a web page. In yet other examples, a virtual assistant may be provided in other manners.

At 304, the virtual assistant service 106 may analyze the first conversation. For example, the virtual assistant service 106 may analyze explicit input from a user, output from a virtual assistant, and/or input/output from a human representative. The analysis may identify user turns, virtual assistant turns, human representative turns, and so on. In some instances, the analysis may identify a duration of a conversation, character or term length of a conversation, and so on.

At 306, the virtual assistant service 106 may determine that an escalation to a human representative occurred in the first conversation. In some instances, operation 306 may include determining that at least one turn in the conversation corresponds to a human representative. In other instances, operation 306 may include determining that the conversation was sent to a human representative to provide a response to the user (e.g., with or without the human representative having actually communicated with the user).

At 308, the virtual assistant service 106 may determine a type of the escalation that occurred in the first conversation. For instance, operation 308 may include determining that the escalation was due to a failure of the virtual assistant (sometimes referred to as a “class III” escalation). As one example, an escalation may be attributed to a failure of the virtual assistant when the virtual assistant service 106 determines that (i) the escalation is not associated with a user greeting, (ii) the first conversation does not include a single turn, and (iii) the escalation is not included in a list of predetermined escalations. As another example, an escalation may be attributed to a failure of the virtual assistant when the virtual assistant service 106 determines that (i) the escalation is not associated with a first escalation class indicating that a user desires to be transferred to a human representative, and (ii) the escalation is not associated with a second escalation class indicating that the virtual assistant is required to transfer to the human representative (e.g., due to being configured in that manner). As yet another example, an escalation may be attributed to a failure of the virtual assistant when the virtual assistant service 106 tags the escalation as a “class III” escalation in the process 400 of FIGS. 4A-4B.

At 310, the virtual assistant service 106 may determine contextual data for the escalation to the human representative. For example, the virtual assistant service 106 may determine contextual data that corresponds to a location in the first conversation where the escalation occurred (e.g., at a specific time or within a window of time). In some implementations, contextual data is determined (or collected) for select cases where the escalation is a particular type of escalation (e.g., a “class III” escalation indicating that the escalation was due to a failure of the virtual assistant). These implementations ignore contextual data for other types of escalations (e.g., “class I” and “class II” escalations). In other implementations, contextual data may be determined (or collected) for any type of escalation.

At 312, the virtual assistant service 106 may determine conversation data for the escalation to the human representative. For example, the virtual assistant service 106 may determine conversation data that corresponds to a location in the first conversation where the escalation occurred (e.g., at a specific time or within a window of time). In some implementations, conversation data is determined (or collected) for select cases where the escalation is a particular type of escalation (e.g., a “class III” escalation indicating that the escalation was due to a failure of the virtual assistant). These implementations ignore conversation data for other types of escalations (e.g., “class I” and “class II” escalations). In other implementations, conversation data may be determined (or collected) for any type of escalation.

At 314, the virtual assistant service 106 may learn that the contextual data and/or the conversation data are associated with escalating to a human representative. Operation 314 may include storing data that correlates the contextual data and/or the conversation data to the escalation. Additionally, or alternatively, operation 314 may include formulating conditions (or setting triggering parameters and/or values of the triggering parameters) for the virtual assistant based on the correlations.

In some implementations, correlations and/or conditions may be set for select cases where the escalation is a particular type of escalation (e.g., a “class III” escalation indicating that the escalation was due to a failure of the virtual assistant). In other implementations, correlations and/or conditions may be set for any type of escalation.

At 316, the virtual assistant service 106 may provide the virtual assistant to facilitate a second conversation. The virtual assistant may be configured according to the learning at operation 314 (e.g., configured to escalate a conversation when one or more conditions are satisfied). The second conversation may be facilitated between the same user of the first conversation or a different user.

At 318, the virtual assistant service 106 may determine to escalate the second conversation to a human representative. For example, the virtual assistant service 106 may monitor conversation data and/or contextual data during the second conversation to detect that one or more conditions associated with an escalation are satisfied.

At 320, the virtual assistant service 106 may cause the second conversation to be transferred to a human representative. Operation 320 may be performed in response to the determination at operation 318. Operation 320 may generally include allowing the human representative to communicate with a user of the second conversation via telephone, email, messaging (e.g., online chat (instant messaging), text message, etc.), video conferencing, audio conferencing, and so on.

In some instances, the second conversation may continue with the human representative with the user knowing that the human representative is involved (e.g., the human representative may identify himself, an indicator may be presented, a different type of dialogue bubble for the human representative may be displayed, etc.). In other instances, the second conversation may continue with the human representative without the user knowing that the human representative is involved.

In instances where the conversation continues without the user knowing that the human representative is involved, the virtual assistant service 106 may, at 322, facilitate a hidden human representative response. This may include receiving input from the human representative, determining a response to the user for the second conversation based on the input from the human representative, and providing the response as originating from the virtual assistant (e.g., providing a dialogue bubble for the response that has an indicator for the virtual assistant).

FIGS. 4A-4B illustrate the example process 400 to filter conversations and/or turns. In some instances, FIG. 4A illustrates a first filtering process (e.g., sub-process) to filter conversations, while FIG. 4B illustrates a second filtering process (e.g., sub-process) to filter turns of a specific conversation. In some instances, the process 400 may filter out (i) “class I” escalations—a transfer to a human representative due to a user immediately requesting the transfer when a conversation begins, and (ii) “class II” escalations—a transfer to a human representative due to a configuration of the virtual assistant (e.g., an escalation required by regulations, laws, business practices, etc.). The process 400 may then tag the resulting turns in the conversation that are associated with an escalation as “class III” escalations—a user attempted to have the virtual assistant perform a task or provide a response, and the virtual assistant failed to do so. In many instances, “class III” escalations represent those escalations that are a failure of the virtual assistant (e.g., the virtual assistant did not operate as intended).

In FIG. 4A, at 402, the virtual assistant service 106 may receive conversation record(s) between one or more virtual assistants, one or more users, and/or one or more human representatives. Each conversation record may include data regarding a conversation. In some instances, operation 402 includes collecting conversation records overtime from a plurality of sources.

At 404, the virtual assistant service 106 may determine whether or not a conversation includes a single user turn. Operation 404 may be performed for each conversation of a plurality of conversations to determine a subset of conversations. If it is determined that the conversation includes a single turn (the “YES” branch), the process 400 may proceed to 406. Alternatively, if it is determined that the conversation does not include a single turn (the “NO” branch), the process 400 may proceed to 408.

At 406, the virtual assistant service 106 may filter the conversation. This may include removing the conversation from a group of conversations that are of interest (e.g., ignoring the conversation). In some instances, operation 406 may include tagging the conversation (or user/virtual assistant turn of the conversation) as “class I.” In many cases, a single turn “class I” tag indicates that a user requested to communicate with a human representative right away and did not provide the virtual assistant with an opportunity to assist the user. Such escalation is not considered a failure of the virtual assistant. Operation 406 may return the conversation, after which the process 400 moves onto the next conversation.

At 408, the virtual assistant service 106 may set a skip value to true.

In FIG. 4B, at 410, the virtual assistant service 106 may determine whether or not a turn in the conversation under analysis includes a user greeting (e.g., salutation, welcome, etc.). In some instances, a greeting classifier may be used to make such determination at operation 410. The greeting classifier may be built with machine learning or other processes. The greeting classifier may take as input user input for the user turn, Parts-of-Speech (POS) tags, hashing vectorizer results, Term Frequency (TF) vectorizer results, other outputs from an NLP system, and so on. The greeting classifier may output a result that indicates whether or not the input relates to a greeting.

Operation 410 may start at an initial turn in a conversation. In some instances, a turn represents a pair—a single user turn and a single virtual assistant turn, while in other instances a turn may represent a single user turn or a single virtual assistant turn.

If, at 410, it is determined that the turn includes a user greeting (the “YES” branch), the process 400 may proceed to 412. Alternatively, if, at 410, it is determined that the turn does not include a user greeting (the “NO” branch), the process 400 may proceed to 414.

At 412, the virtual assistant service 106 may filter the turn. In some instances, operation 412 may include designating the turn as not being of interest (e.g., ignoring the turn). Alternatively, or additionally, operation 412 may include tagging the turn as “class I” (or as a user greeting “class I”).

At 416, the virtual assistant service 106 may increment to the next turn in the conversation and return to “A” to repeat operation 410 on the next turn in the conversation.

At 414, the virtual assistant service 106 may determine whether or not the turn includes an escalation. In some instances, this may include determining whether or not the turn directly precedes or follows an escalation to a human representative. As such, operation 414 may identify turns around a same time as an escalation.

In some instances, an escalation classifier may be used to make such determination at operation 414. The escalation classifier may be built with machine learning or other processes. The escalation classifier may take as input user input for the user turn, Parts-of-Speech (POS) tags, hashing vectorizer results, Term Frequency (TF) vectorizer results, other outputs from an NLP system, and so on. The escalation classifier may output a result that indicates whether or not the input relates to an escalation to a human representative.

If, at 414, it is determined that the turn includes an escalation (the “YES” branch), the process 400 may proceed to 418. Alternatively, if, at 414, it is determined that the turn does not include an escalation (the “NO” branch), the process 400 may proceed to 420.

At 420, the virtual assistant service 106 may filter the turn. In some instances, operation 420 may include designating the turn as not being of interest (e.g., ignoring the turn). Alternatively, or additionally, operation 420 may include tagging the turn as not being related to an escalation.

At 422, the virtual assistant service 106 may increment to the next turn in the conversation, set the skip value to false, and return to “A”.

At 418, the virtual assistant service 106 may determine whether or not the skip value is set to true. In some instances, the skip value is set to true when (i) the turn is the initial user turn in a conversation, (ii) the turn follows a user greeting, or (iii) the turn is one of a sequential series of user turns requesting to escalate, where the sequential series of user turns includes an initial user turn in the conversation.

If, at 418, it is determined that the skip value is set to true (the “YES” branch), the process 400 may proceed to 424. Alternatively, if, at 418, it is determined that the skip value is not set to true (set to false) (the “NO” branch), the process 400 may proceed to 426.

At 424, the virtual assistant service 106 may filter the turn. In some instances, operation 424 may include designating the turn as not being of interest (e.g., ignoring the turn). Alternatively, or additionally, operation 424 may include tagging the turn as “class I” (or as a “1 . . . n class I”). In some instances, the tag applied at operation 424 may indicate that (i) the turn is the initial user turn in a conversation that relates to escalation, (ii) the turn follows a user greeting and relates to escalation, or (iii) the turn is one of a sequential series of user turns requesting to escalate, where the sequential series of user turns includes an initial user turn in the conversation (e.g., the user asks up front for a transfer and continues to ask for a transfer each time the user communicates).

At 428, the virtual assistant service 106 may increment to the next turn in the conversation and return to “A”.

At 426, the virtual assistant service 106 may determine whether or not the turn is associated with an escalation from a predetermined list of escalations. The predetermined list of escalations may indicate, for example, escalations that are required by regulations, laws, business practices, etc.

If, at 426, it is determined that the turn is associated with an escalation from the predetermined list of escalations (the “YES” branch), the process 400 may proceed to 430. Alternatively, if, at 426, it is determined that the turn is not associated with an escalation from the predetermined list of escalations (the “NO” branch), the process 400 may proceed to 432.

At 430, the virtual assistant service 106 may filter the turn. In some instances, operation 430 may include designating the turn as not being of interest (e.g., ignoring the turn). Alternatively, or additionally, operation 430 may include tagging the turn as “class II.” In many instances, a “class II” escalation is not a failure of the virtual assistant, since the virtual assistant operated as intended (e.g., it was configured to escalate in such situation).

At 434, the virtual assistant service 106 may increment to the next turn in the conversation, set the skip value to false, and return to “A”.

At 432, the virtual assistant service 106 may tag the turn with a particular identifier, such as “class III” escalation. A “class III” escalation may represent an escalation that is a failure of the virtual assistant.

At 436, the virtual assistant service 106 may increment to the next turn in the conversation, set the skip value to false, and return to “A”.

Although not illustrated in FIG. 4A or 4B, in some instances the results of the process 400 may be provided to a user (e.g., an administrator of the virtual assistant), so that the user may fix the virtual assistant (e.g., the underlying model). In one example, turns that have been tagged as “class III” escalations (e.g., indicating a failure of the virtual assistant), may be provided to a user with an indicator indicating such tag. The user may review those escalations and fix portions of the virtual assistant (including the underlying NLP system) so that such escalations do not occur in future conversations. This may avoid the user from having to review thousands of escalations where the virtual assistant operated as intended. In another example, any type of turn may be provided to a user for review.

### Example Virtual Assistant Service

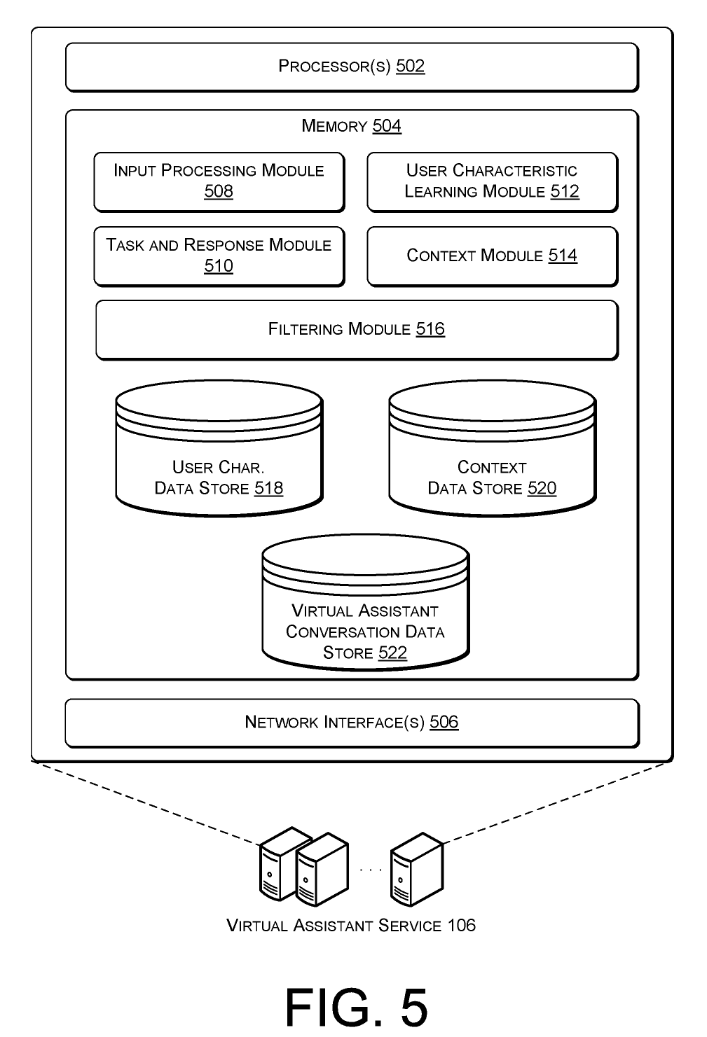

FIG. 5 illustrates details of the example virtual assistant service 106 of FIG. 1. As noted above, the virtual assistant service 106 may be implemented as one or more computing devices. The one or more computing devices may include one or more processors 502, memory 504, and one or more network interfaces 506. The one or more processors 502 may include a central processing unit (CPU), a graphics processing unit (GPU), a microprocessor, a digital signal processor, and so on.

The memory 504 may include software functionality configured as one or more “modules.” The term “module” is intended to represent example divisions of the software for purposes of discussion, and is not intended to represent any type of requirement or required method, manner or necessary organization. Accordingly, while various “modules” are discussed, their functionality and/or similar functionality could be arranged differently (e.g., combined into a fewer number of modules, broken into a larger number of modules, etc.). Further, while certain functions are described herein as being implemented as software modules configured for execution by a processor, in other embodiments, any or all of the functions may be implemented (e.g., performed) in whole or in part by hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), etc.

As illustrated in FIG. 5, the memory 504 includes an input processing module 508, a task and response module 510, a user characteristic learning module 512, a context module 514, and a filtering module 516.

The input processing module 508 may be configured to perform various techniques to process input received from a user. For instance, input that is received from a user during a conversation with a virtual assistant may be sent to the input processing module 508 for processing. If the input is speech input, the input processing module 508 may perform speech recognition techniques to convert the input into a format that is understandable by a computing device, such as text. Additionally, or alternatively, the input processing module 508 may perform Natural Language Processing (NLP) to interpret or derive a meaning and/or a concept of the input.

The task and response module 510 may be configured to identify and/or perform tasks and/or formulate a response to input. As noted above, users may interact with virtual assistants to cause tasks to be performed by the virtual assistants. In some instances, a task may be performed in response to explicit user input, such as playing music in response to “please play music.” In other instances, a task may be performed in response to inferred user input requesting that that the task be performed, such as providing weather information in response to “the weather looks nice today.” In yet further instances, a task may be performed when an event has occurred (and possibly when no input has been received), such as providing flight information an hour before a flight, presenting flight information upon arrival of a user at an airport, and so on.

A task may include any type of operation that is performed at least in part by a computing device. For example, a task may include logging a user into a site, setting a calendar appointment, resetting a password for a user, purchasing an item, opening an application, sending an instruction to a device to perform an act, sending an email, navigating to a web site, upgrading a user's seat assignment, outputting content (e.g., outputting audio (an audible answer), video, an image, text, a hyperlink, etc.), and so on. Further, a task may include performing an operation according to one or more criteria (e.g., one or more default settings), such as sending an email through a particular email account, providing directions with a particular mobile application, searching for content through a particular search engine, and so on.

A task may include or be associated with a response to a user (e.g., “here is your requested information” and then providing the information). A response may be provided through a conversation user interface associated with a virtual assistant. In some instances, a response may be addressed to or otherwise tailored to a user (e.g., “Yes, John, as a Gold Customer you are entitled to a seat upgrade, and I have provided some links below that may be of interest to you.”).

The user characteristic learning module 512 may be configured to observe user activity and attempt to learn characteristics about a user. The user characteristic learning module 512 may learn any number of characteristics about the user over time, such as user preferences (e.g., likes and dislikes), track patterns (e.g., user normally reads the news starting with the sports, followed by the business section, followed by the world news), behaviors (e.g., listens to music in the morning and watches movies at night, speaks with an accent, prefers own music collection rather than looking for new music in the cloud, etc.), and so on. To observe user activity and learn a characteristic, the user characteristic learning module 512 may access a user profile, track a pattern, monitor navigation of the user, and so on. Learned user characteristics may be stored in a user characteristic data store 518.

As an example of learning a user characteristic, consider a scenario where a user incorrectly inputs “Cobo” or a speech recognition system incorrectly recognized the user input as “Cobo”. Once the user corrects this to say “Cabo”, the user characteristic learning module 512 can record this correction from “Cobo” to “Cabo” in the event that a similar situation arises in the future. Thus, when the user next speaks the phrase “Cabo San Lucas”, and even though the speech recognition might recognize the user input as “Cobo”, the virtual assistant service 106 will use the learned correction and make a new assumption that the user means “Cabo” and respond accordingly. As another example, if a user routinely asks for the movie “Crazy”, the user characteristic learning module 512 will learn over time that this is the user preference and make this assumption. Hence, in the future, when the user says “Play Crazy”, the virtual assistant service 106 will make a different initial assumption to begin play of the movie, rather than the original assumption of the song “Crazy” by Willie Nelson.

The context module 514 may be configured to identify (e.g., determine) one or more pieces of contextual data. Contextual data may be used in various manners. For instance, contextual data may be used by the input processing module 508 to determine an intent or meaning of a user's input. In addition, after identifying the user's intent, the same or different contextual data may be taken into account by the task and response module 510 to determine a task to be performed or a response to provide back to the user. Further, contextual data may be used by the user characteristic learning module 512 to learn characteristics about a user. Additionally, or alternatively, contextual data may be used by the filtering module 516.

Generally, contextual data may comprise any type of information that is associated with a user, a device, or other information. In some instances, contextual data is expressed as a value of one or more variables, such as whether or not a user has signed in with a site (e.g., “is_signed_in =true” or “is_signed_in =false”). When contextual data is associated with a user, the contextual data may be obtained with the explicit consent of the user (e.g., asking the user if the information may be collected). Contextual data may be stored in a context data store 520. Example contextual data may include:
A geographic location of a user (e.g., a previous, current, or future location of a user or device associated with the user).
A sentiment of a user (e.g., angry, sad, happy, content, etc.).
A reading from a sensor of a smart device (e.g., heart rate reading, image from a camera, magnetometer/accelerometer reading, temperature reading, etc.).
A calendar event (e.g., a scheduled flight, a work meeting, etc.).
Weather conditions (e.g., rainy, windy, sunny, snowing, icy, etc.).
A time of day or date.
An input mode that used by a user (e.g., text, touch, type, speech, etc.). In some instances, the input mode may indicate a user prefer for a particular type of mode (e.g., whether the user prefers to submit a query textually, using voice input, touch input, gesture input, etc.). A preferred input mode may be inferred from previous interactions, explicit input of the user, profile information, etc.
User preference information describing a preference of a user (e.g., a seat preference, a home airport, a preference of whether schedule or price is important to a user, a type of weather a user enjoys, types of items acquired by a user, types of stock a user owns or sold, etc.).
User profile information (e.g., information identifying friends/family of a user, information identifying where a user works or lives, information identifying a user's car, a preference of a user, demographic information, etc.).
An age or gender of a user.
Content output history describing content that has been output to a user during a conversation or at any time. For example, the output history may indicate that a sports web page was output to a user during a conversation. In another example, the output history may identify a song that a user listened to on a home stereo receiver or a movie that was played on a television.
Message information describing a message that has been sent via a messaging service (e.g., a text message, an email, an instant messaging message, a telephone call, etc.). The messaging information may identify the content of the message, who the message was sent to, from whom the message was sent, etc.
A location of a cursor on a site when a user provides input to a virtual assistant.
Device information indicating a device type with which a user interacts with a virtual assistant (e.g., a mobile device, a desktop computer, game system, etc.).
An orientation of a device which a user is using to interact with a virtual assistant (e.g., landscape or portrait).
A communication channel which a device of a user uses to interface with a virtual assistant service (e.g., wireless network, wired network, etc.).
A language associated with a user (e.g., a language of a query submitted by the user, what languages the user speaks, etc.).
How an interaction with a virtual assistant is initiated (e.g., via user selection of a link or graphic, via the virtual assistant proactively engaging a user, etc.).
How a user has been communicating recently (e.g., via text messaging, via email, etc.).
Information derived from a user's location (e.g., current, forecasted, or past weather at a location, major sports teams at the location, nearby restaurants, etc.).
Current topics of interest, either to a user or generally (e.g., trending micro-blog or blog topics, current news, recent micro-blog or blog posts made by the user, etc.).
Whether or not a user has signed-in with a site of a service provider (e.g., with a user name and password).
A status of a user with a service provider (e.g., based on miles flown, a type of membership of the user, a type of subscription purchased by the user, etc.).
A page of a site from which a user provides a query to a virtual assistant.
How long a user has remained on a page of a site from which the user provides a query to the virtual assistant.
Social media information describing interactions of a user via a social networking service (e.g., posts or other content that have been viewed and/or posted to a social networking site or blog).
Search information describing search input received from a user and search output provided to the user (e.g., a user searched for “luxury cars,” and 45 search results were returned).
Purchase history identifying items that have been acquired by a user.
Any characteristic of a user (e.g., learned characteristics).

In some instances, contextual data may indicate data that is specific to a failure of a virtual assistant. For example, contextual data may indicate a geographic location of a user when an escalation to a human representative occurred.

The filtering module 516 may be configured to perform various operations described in references to FIGS. 2-4. For example, the filtering module 516 may analyze conversations to determine failures that are attributable to virtual assistants, learn contextual/conversation data related to a failure, and so on. In some instances, the filtering module 516 may detect conditions in conversations to escalate conversations. Further, in some instances the filtering module 516 may filter turns or conversations, classify turns or conversations, and so on.

Conversation data may generally describe a conversation between a user, virtual assistant, and/or human representative. For example, conversation data may include input and/or output from users, virtual assistants, and/or human representatives. Additionally, conversation data may include data determined by processing input/output of a user/virtual assistant/human representative, such as with NLP. Conversation data may be stored in a virtual assistant conversation data store 522. Example conversation data may include:
User input (e.g., words used by a user during an interaction with a virtual assistant or human representative).
A response of a virtual assistant (e.g., words used by a virtual assistant during an interaction with a user).
A response of a human representative (e.g., words used by a human representative during an interaction with a user).
A task that is performed by a virtual assistant (e.g., a task performed in response to a user request).
A task that is performed by a human representative (e.g., a task performed in response to a user request).
A duration of time of a conversation. In some instances, a duration of time may be with respect to a failure of a virtual assistant (e.g., a duration of time up to an escalation).
A number of turns in a conversation. In some instances, a number of turns may be with respect to a failure of a virtual assistant (e.g., a number of turns up to an escalation).
A length of user input, virtual assistant output, or human representative output (e.g., character length, word length, etc.).
A goal that is determined for responding to user input. For example, to respond to a request from a user to “book a flight,” a virtual assistant may perform a goal of collecting information about the user, such as the user's name, address, age, etc. Other goals may also be performed to accomplish the task of booking a flight.
Natural Language Processing (NLP) output, such as a concept determined by an NLP system for user input, an intent of a user that is determined by an NLP system, a vocab component determined by an NLP system for user input, a helper component determined by an NLP system for user input, a building block determined by an NLP system for user input, a wild card (e.g., placeholder), or any other data that is provided by a NLP system. In some instances, a concept may be represented as a pattern of terms or components. A component may include a vocab component (e.g., a list of synonyms and/or spelling variations for a term in user input), a helper component (e.g., conjunctions, such as “and,” “is,” “for,” “the,” etc.), a building block (e.g., an arrangement of vocab components, helper components, concepts, etc.), a wild card, etc.

In some instances, conversation data may indicate data that is specific to a failure of a virtual assistant. For example, conversation data may indicate a concept that is determined for user input that occurred at a time of an escalation to a human representative.

Although the modules 508-516 are illustrated as being included in the virtual assistant service 106, in some instances one or more of these modules may be included in the smart device 102, the computing device 114, or elsewhere. As such, in some examples the virtual assistant service 106 may be eliminated entirely, such as in the case when all processing is performed locally at the smart device 102 (e.g., the smart device 102 operates independently). In addition, in some instances any of the data stores 518-522 may be included in elsewhere, such as within the smart device 102, the computing device 114, and/or the service provider 108.

In some instances, the virtual assistant services 106 use machine learning techniques.

Further, in some instances, a conversation may be escalated to a human representative when a user is mad, frequently (more than a particular number of times in the past) has requested to speak with a human representative, the user is asking a relatively technical problem, the user asks a question that requires a licensed individual (e.g., medical doctor, financial advisor, attorney, etc.) to answer, the user asks a question that is relatively abstract, and so on. As such, the virtual assistant service 106 may be configured to escalate in such instances (e.g., with conditions).

### Example Smart Device

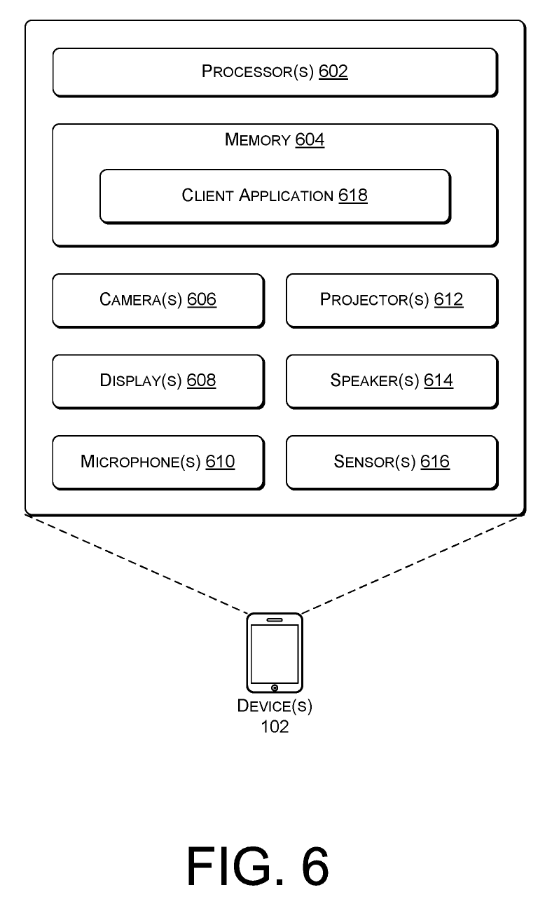

FIG. 6 illustrates details of the example smart device 102 of FIG. 1. The smart device 102 may be equipped with one or more processors 602, memory 604, one or more cameras 606, one or more displays 608, one or more microphones 610, one or more projectors 612, one or more speakers 614, and/or one or more sensors 616. The components 604-616 may be communicatively coupled to the one or more processors 602. The one or more processors 602 may include a central processing unit (CPU), a graphics processing unit (GPU), a microprocessor, a digital signal processor, and so on. The one or more cameras 606 may include a front facing camera and/or a rear facing camera. The one or more displays 608 may include a touch screen, a Liquid-crystal Display (LCD), a Light-emitting Diode (LED) display, an organic LED display, a plasma display, an electronic paper display, or any other type of technology. The one or more sensors 616 may include an accelerometer, compass, gyroscope, magnetometer, Global Positioning System (GPS), olfactory sensor (e.g., for smell), blood pressure sensor, heart rate monitor, eye tracking sensor, thermometer, or other sensor. The components 606-616 may be configured to receive user input, such as gesture input (e.g., through the camera), touch input, audio or speech input, and so on, and/or may be configured to output content, such as audio, images, video, and so on. In some instances, the one or more displays 608, the one or more projectors 612, and/or the one or more speakers 614 may comprise a content output device configured to output content and/or a virtual assistant. In one example, the one or more projectors 612 may be configured to project a virtual assistant (e.g., output an image on a wall, present a hologram, etc.). Although not illustrated, the smart device 102 may also include one or more network interfaces.

The memory 604 may include a client application 618 (e.g., module) configured to implement a virtual assistant on a user-side. In many instances, the client application 618 may provide a conversation user interface to implement a virtual assistant. A conversation user interface may provide conversation representations (sometimes referred to as dialog representations) representing information from a virtual assistant, information from the user, and/or information from a human representative. For example, in response to a query from a user to “find the nearest restaurant,” the conversation user interface may display a dialog representation of the user's query and a response item of the virtual assistant that identifies the nearest restaurant to the user. A conversation representation may comprise an icon (e.g., selectable or non-selectable), a menu item (e.g., drop down menu, radio control, etc.), text, a link, audio, video, or any other type of information.

The client application 618 may receive any type of input from a user, such as audio or speech, text, touch, or gesture input received through a sensor of the smart device 102. The client application 618 may also provide any type of output, such as audio, text, interface items (e.g., icons, buttons, menu elements, etc.), and so on. In some implementations, the client application 618 is implemented as, or in association with, a mobile application, a browser (e.g., mobile browser), and so on.

The memory 604 (as well as the memory 504 and/or all other memory described herein) may include one or a combination of computer readable media (sometimes referred to as computer readable storage media or computer storage media). Computer readable media includes volatile and non-volatile, removable and non-removable media implemented in any method or technology for storage of information, such as computer readable instructions, data structures, program modules, or other data. Computer readable media includes, but is not limited to, phase change memory (PRAM), static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transitory medium that can be used to store information for access by a computing device. As defined herein, computer readable media does not include communication media, such as modulated data signals and carrier waves. As such, computer readable media is non-transitory media.

### CONCLUSION

Although embodiments have been described in language specific to structural features and/or methodological acts, it is to be understood that the disclosure is not necessarily limited to the specific features or acts described. Rather, the specific features and acts are disclosed herein as illustrative forms of implementing the embodiments.

What is claimed is:

1. A method comprising:
providing, by a computing device, a virtual assistant via a smart device to facilitate a first conversation between a user and the virtual assistant;
analyzing, by the computing device, the first conversation, the analyzing including analyzing at least one of explicit user input or output from the virtual assistant;
based at least in part on the analysis:
determining that an escalation to a human representative occurred in the first conversation; and
determining a type of the escalation that occurred in the first conversation;
based at least in part on the type of the escalation, determining contextual data for the escalation;
based at least in part on the type of the escalation, determining conversation data for the escalation, the conversation data comprising at least one of (i) user input at the escalation, (ii) a response of the virtual assistant at the escalation, (iii) a goal that is determined for responding to the user input at the escalation, (iv) a task that was performed by the virtual assistant at the escalation, (v) Natural Language Processing (NLP) output from processing the user input at the escalation, (vi) a duration of time in the first conversation up to the escalation, (vii) a number of turns in the first conversation up to the escalation, or (viii) a length of the user input or virtual assistant output at the escalation;
learning, by the computing device, that the contextual data and the conversation data are associated with the escalation to the human representative;
providing the virtual assistant via the smart device or another smart device to facilitate a second conversation between the virtual assistant and the user or another user;
based at least in part on the learning, determining to escalate the second conversation to at least one of the human representative or another human representative; and
causing the second conversation to be transferred to at least one of the human representative or the other human representative.

2. The method of claim 1, wherein the determining the type of escalation that occurred in the first conversation includes:
determining that the escalation is not associated with a user greeting;
determining that the first conversation does not include a single turn;
determining that the escalation is not included in a list of predetermined escalations; and
determining that the escalation is a particular type of escalation indicating that the escalation was due to a failure of the virtual assistant.

3. The method of claim 1, wherein the determining the type of escalation that occurred in the first conversation includes:
determining that the escalation is not associated with a first escalation class, the first escalation class indicating that a user desires to be transferred to the human representative;
determining that the escalation is not associated with a second escalation class, the second escalation class indicating that the virtual assistant is required to transfer to the human representative; and
based at least in part on determining that the escalation is not associated with the first escalation class and the second escalation class, determining that the escalation is associated with a third escalation class, the third escalation class indicating that the escalation was due to a failure of the virtual assistant.

4. The method of claim 1, wherein the NLP output comprises at least one of:
a concept determined for user input at the escalation;
a vocab term determined for the user input at the escalation;
a building block determined for the user input at the escalation; or
an intent determined for the user input at the escalation

5. The method of claim 1, wherein the contextual data comprises at least one of:
a geographic location of the user when the escalation occurred in the first conversation;
a sentiment of the user when the escalation occurred in the first conversation;
a sensor reading from the smart device obtained when the escalation occurred in the first conversation;
a calendar event during a period of time that includes the escalation;
weather conditions when the escalation occurred in the first conversation;
a time of day when the escalation occurred in the first conversation;
an input mode used by the user when the escalation occurred in the first conversation; or
user profile information for the user.

6. The method of claim 1, further comprising:
receiving input from at least one of the human representative or the other human representative;
determining a response for the second conversation based at least in part on the input from the human representative or the other human representative; and
providing the response during the second conversation as originating from the virtual assistant.

7. A system comprising:
one or more processors; and
memory communicatively coupled to the one or more processors and storing executable instructions that, when executed by the one or more processors, cause the one or more processors to perform acts comprising:
receiving a conversation record regarding a conversation between a virtual assistant and a user;
determining that a failure occurred in the conversation that is attributable to the virtual assistant;
determining a location in the conversation where the failure occurred;
determining contextual data for the location in the conversation;
determining conversation data for the location in the conversation; and
learning that the contextual data and the conversation data are associated with the failure.

8. The system of claim 7, wherein the determining that the failure occurred in the conversation that is attributable to the virtual assistant comprises determining that the virtual assistant was unable to provide a response or perform a task that satisfies user input in the conversation.

9. The system of claim 7, wherein the determining that the failure occurred in the conversation that is attributable to the virtual assistant comprises determining that an escalation to a human representative occurred in the conversation.

10. The system of claim 7, wherein the determining that the failure occurred in the conversation that is attributable to the virtual assistant comprises determining that a sentiment of the user changed from a first state to second state due to a response from the virtual assistant.

11. The system of claim 7, wherein the determining that the failure occurred in the conversation that is attributable to the virtual assistant comprises determining that a sentiment of the user changed from a first state to second state due to a task that was performed by the virtual assistant.

12. The system of claim 7, wherein the determining that the failure occurred in the conversation that is attributable to the virtual assistant comprises:
determining that the conversation does not include a single user turn;
determining that the conversation is associated with an escalation to a human representative;
determining that the conversation includes at least one user turn that is (i) not related to the escalation and (ii) not a user greeting;
determining that the escalation is not included in a list of predetermined escalations; and
determining that the failure is attributable to the virtual assistant.

13. The system of claim 7, wherein the operations further comprise:
providing the virtual assistant via the smart device or another smart device to facilitate another conversation between the virtual assistant and the user or another user;
based at least in part on the learning, determining to escalate, during the other conversation, to a human representative; and
causing the other conversation to be transferred to the human representative.

14. The system of claim 7, wherein the contextual data comprises at least one of:
a geographic location of the user when the failure occurred in the conversation;
a sentiment of the user when the failure occurred in the conversation;
a sensor reading from the smart device obtained when the failure occurred in the conversation;
a calendar event during a period of time that includes the failure;
weather conditions when the failure occurred in the conversation;
a time of day when the failure occurred in the conversation;
an input mode used by the user when the failure occurred in the conversation; or
user profile information for the user.

15. The system of claim 7, wherein the conversation data comprises at least one of:
user input at the failure;
a response of the virtual assistant at the failure;
a goal that is determined for responding to the user input at the failure;
a task that was performed by the virtual assistant at the failure;
Natural Language Processing (NLP) output from processing the user input at the failure;
a duration of time in the first conversation up to the failure;
a number of turns in the first conversation up to the failure; or
a length of the user input or virtual assistant output at the failure.

16. One or more non-transitory computer readable media storing computer-readable instructions that, when executed, instruct one or more processors to perform operations comprising:
receiving conversation records, the conversation records including data regarding a plurality of conversations;
performing a first filtering process with the plurality of conversations to remove conversations that each include a single user turn, the first filtering process determining a subset of the plurality of conversations;
performing a second filtering process with a first conversation in the subset of the plurality of conversations, the second filtering process including:
filtering out user turns in the first conversation that are associated with a greeting;
filtering out user turns in the first conversation that are part of a sequential series of user turns requesting to escalate where the sequential series of user turns includes an initial user turn in the first conversation; and
filtering out user turns in the first conversation that are associated with an escalation from a list of predetermined escalations;
determining that an escalation is associated with a particular user turn in the first conversation that has not been filtered out in the second filtering process; and
tagging, with an identifier, the particular user turn, the identifier indicating that the escalation was due to a failure of the virtual assistant.

17. The one or more non-transitory computer readable media of claim 16, wherein the operations further comprise:
based at least in part on tagging the user turn with the identifier:
determining contextual data at a time of the escalation associated with the particular user turn;
determining conversation data at the time of the escalation associated with the particular user turn; and
learning that the contextual data and the conversation data are associated with escalating to a human representative.

18. The one or more non-transitory computer readable media of claim 17, wherein the contextual data comprises at least one of:
a geographic location of the user during the first conversation;
a sentiment of the user during the first conversation;
a sensor reading obtained during the first conversation;
a calendar event during a period of time that includes the escalation;
weather conditions during the first conversation;
a time of day when the first conversation occurred;
an input mode used during the first conversation; or
user profile information for a user of the first conversation.

19. The one or more non-transitory computer readable media of claim 17, wherein the conversation data comprising at least one of:
user input at the escalation;
a response of a virtual assistant at the escalation;
a goal that is determined for responding to the user input at the escalation;
a task that was performed by the virtual assistant at the escalation;
Natural Language Processing (NLP) output from processing the user input at the escalation;
a duration of time in the first conversation up to the escalation;
a number of turns in the first conversation up to the escalation; or
a length of the user input or virtual assistant output at the escalation.

20. The one or more non-transitory computer readable media of claim 19, wherein the NLP output comprises at least one of:
a concept determined for the user input at the escalation;
a vocab term determined for the user input at the escalation;
a building block determined for the user input at the escalation; or
an intent determined for the user input at the escalation.
